(19) United States
(12) Patent Application Publication
(10) Pub. No.: US 2026/0149727 A1
(43) Pub. Date: May 28, 2026

(54) ANOMALY DETECTION IN NETWORK FUNCTION OBSERVABILITY

(71) Applicant: HEWLETT PACKARD ENTERPRISE DEVELOPMENT LP, Spring, TX (US)

(72) Inventors: Biswadeb Dutta, Chestnut Hill, MA (US); Zishan Kamal, Bangalore (IN); Raul De Diego Merino, Madrid (ES)

(21) Appl. No.: 19/042,191

(22) Filed: Jan. 31, 2025

(30) Foreign Application Priority Data
Nov. 26, 2024 (IN) 202411092181

(51) Int. Cl. H04L 9/40; H04L 41/16

(52) U.S. Cl. CPC H04L 63/1425; H04L 41/16

(57) ABSTRACT

Systems and methods are provided for performing anomaly detection. An example method includes, in a training phase, performing time series decomposition on training time series data to extract residuals of the training time series data, the residuals including a plurality of data points of the training time series data, using unsupervised anomaly detection models, identifying and labeling anomalous data points from among the plurality of data points contained in the residuals, based on outputs from the ensemble of unsupervised models including the labeled anomalous data points, obtaining a combined output indicating the labeled anomalous data points, and, using the combined output, training supervised anomaly detection models to detect anomalies in inference time series data In an inference phase, the method includes, using the trained ensemble of supervised anomaly detection models, on real-time, inference time series data.

### BACKGROUND

Modern networks (e.g., telecommunications networks, such as 5G networks) are operated and managed using observability data generated by containerized and virtualized network functions. Observability data may include, for example, event logs, metrics (e.g., counters or other numerical values representing characteristics of network services, functions, and/or infrastructure, such as dropped calls, CPU usage, data rates, latency, etc.), and traces. In some examples, various anomaly detection techniques may be used in network resource management to detect, based on the observability data, network resource and other problems that impact network functions and services.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1A illustrates one example configuration of a system configured to implement anomaly detection systems and methods according to the principles of the present disclosure.

FIG. 1B illustrates an example anomaly detection system implemented by the system of FIG. 1A according to the principles of the present disclosure.

FIGS. 2A, 2B, and 2C illustrate an example anomaly detection system according to the principles of the present disclosure.

FIG. 3 illustrates a computing device or platform that may be used to perform anomaly detection according to the principles of the present disclosure.

FIG. 4 depicts a block diagram of an example computer system 400 in which various examples of the disclosed technology described herein may be implemented.

The figures are not exhaustive and do not limit the present disclosure to the precise form disclosed.

### DETAILED DESCRIPTION

Anomaly detection techniques may be used in network resource management to detect, based on observable (or “observability”) data, network resource and other problems that impact network functions and services. Advances in network functionality have dramatically increased size and complexity of various operations, including the amount and complexity of observability data used for anomaly detection. Accordingly, there are various challenges associated with analyzing and processing observability data datasets.

For example, the datasets generated by network resources (which may be referred to as network functions, or NFs) are extremely large. As one example, a typical (single) 4G radio access network (RAN) generates several thousand raw measurements per unit time, and a network may include hundreds of thousands of RAN devices, resulting in billions of raw measurements. Further, univariate time series are weakly correlated with each other. Accordingly, dimensionality of a complete multivariate time series dataset cannot be reduced by employing a dimensionality reduction algorithm (e.g., Principal Component Analysis), or by dropping one time series from a pair of highly correlated time series prior to attempting anomaly detection. As other examples of challenges associated with performing anomaly detection, telecommunications domain data is unlabeled (i.e., the data is not labeled/marked as normal or anomalous), and a proportion of anomalies present in the data is highly skewed.

Further, anomaly detection techniques have various deficiencies when applied to raw metrics associated with network observability data, which include inherent time series properties such as trend and seasonality. For example, time series data includes components such as trend, seasonality and residuals.

Anomaly detections systems and methods according to the present disclosure are configured to detect and label anomalies in time series network observability data using a combination of unsupervised and supervised models (e.g., artificial intelligence (AI)-based, machine learning models). For example, time series decomposition is performed on training time series data (e.g., raw physical data and measurements contained in historical unlabeled time series data) to remove trend and seasonality and extract the residuals. A plurality (which may be referred to as an “ensemble”) of unsupervised models are trained using the residuals to obtain labeled anomalies. The supervised models are trained using the labeled anomalies. The trained supervised models may then be used to perform inference tasks on time series network observability data (i.e., to detect and predict anomalies in real-time).

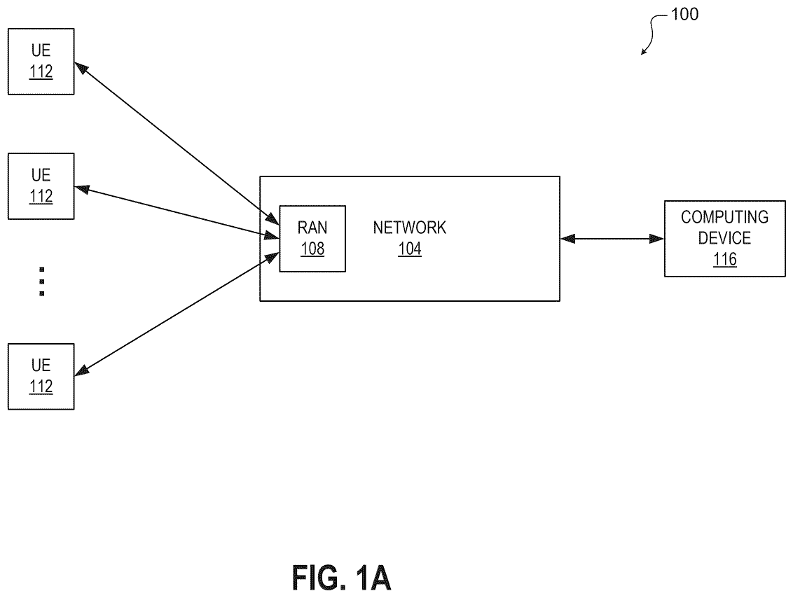

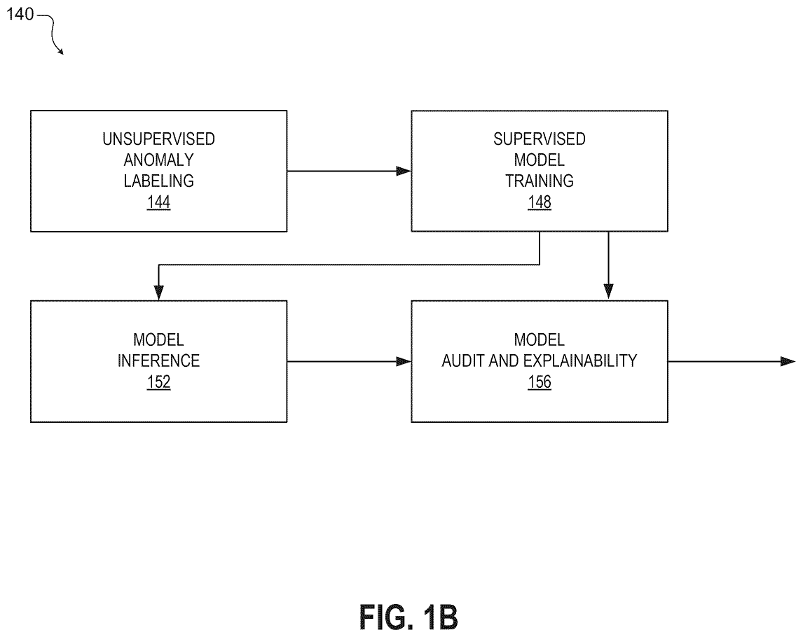

Before describing various examples of the disclosed systems and methods in detail, it is useful to describe an example network installation with which these systems and methods might be implemented in various applications. FIG. 1A illustrates one example configuration of a system 100 (e.g., a telecommunications network, such as a 5G cellular network) configured to implement anomaly detection systems and methods according to the present disclosure. Although described with respect to a telecommunications network, the principles of the present disclosure may be implemented for other types of systems and networks, such as a wireless local area network (WLAN), a wired network, etc.

In this example, the system 100 includes a network 104 (e.g., a core network infrastructure that provides various network functions), one or more access networks or devices, such as a radio access network (RAN) 108, and client or user equipment (UE) devices 112 (e.g., cellular phones or other mobile devices) configured to access network functions and resources of the network 104 via the RAN 108. For example, one or more of the RANs 108 may be configured to provide, to respective pluralities of the UE devices 112, access to network functions and resources of the network 104.

Examples of UE devices may include, but are not limited to: desktop computers, laptop computers, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

The network 104 may be a telecommunications network, such as a 5G cellular network. In other examples, the network 104 may be a public or private network, such as the Internet, or other communication network to allow connectivity among various devices and sites. The network 104 may include third-party telecommunication lines, such as phone lines, broadcast coaxial cable, fiber optic cables, satellite communications, cellular communications, and the like. The network 104 may include any number of intermediate network devices, such as switches, routers, gateways, servers, and/or controllers, which are not directly part of the system 100 but that facilitate communication between the various parts of the system 100, and between the system 100 and other network-connected entities.

The network 104 may include and/or communicate with various servers, computing devices, etc., shown in FIG. 1A as computing platform or device 116. The computing device 116 may include various types of computing devices and servers, such as network resource servers, content servers, cloud computing devices or systems, etc. The computing device 116 may be configured to implement anomaly detection systems and methods of the present disclosure. For example, the computing device 116 is configured to receive network observability data (e.g., time series network observability data) from the network 104 and detect and label anomalies in the time series network observability data as described below in more detail.

As one example, the computing device 116 may implement an artificial intelligence (AI) engine configured to execute one or more AI or machine learning (ML) models trained using training time series data (e.g., historical unlabeled time series data) obtained during operation of the system 100. Various components of the training data, AI engine, ML models, etc. may be stored within the computing device 116 or external to the computing device 116 (e.g., in a remote server, a cloud computing system, etc.).

As described below in more detail, a plurality of unsupervised models are trained to label raw physical measurements (e.g., residuals of time series observability data) and output labeled anomalies. Supervised models are then trained using the labeled anomalies to predict anomalies in real-time (e.g., to perform inference tasks on time series network observability data). Since no single anomaly prediction method, model, or technique is ideal for all situations, multiple techniques (and corresponding models) are used. Example approaches include distance-based approaches, density-based approaches, tree based approaches, isolation mechanism approaches, etc. Accordingly, systems and methods of the present disclosure implement a plurality of unsupervised models or techniques and combine the results from these techniques to improve the overall performance and robustness of the unsupervised learning. Example techniques include, but are not limited to, K-means clustering techniques, density-based spatial clustering of applications with noise (DBSCAN) techniques, Gaussian mixture model (GMM) techniques, isolation forest techniques, local outlier factor techniques, robust covariance techniques, and one class support vector machine techniques. Outputs/results of two more techniques are provided to an ensemble algorithm (e.g., as implemented by a result combination module) configured to generate an output (e.g., labeled anomalies) based on the combined results. For example, the ensemble algorithm may include a majority voting algorithm, a weighted average algorithm, etc. Generating a combined result of multiple unsupervised techniques as described herein provides flexibility and customization capability to achieve a generalizable solution. The supervised models are then trained using the labeled anomalies to predict anomalies in real-time as a binary classification task (i.e., to predict, in a binary fashion, whether a given data point is “normal” or “anomalous”).

Typically, the proportion of anomalies in the time series data is highly skewed/imbalanced (e.g., a relatively small amount of anomalies relative to the overall time series data). Accordingly, in some examples, data imbalance can be mitigated or corrected by: selecting appropriate evaluation metrics (e.g., precision, recall, F1-score, etc.); tuning the model specific hyperparameters to compensate for imbalanced data (e.g., class weight, scale_pos_weight, etc.), establishing a validation framework to ensure that the proportion of anomalies is similar in both training and test datasets; and evaluating different sampling techniques to address the data imbalance (e.g., a synthetic minority oversampling technique (SMOTE)).

Example classification techniques for the supervised models include, but are not limited to, logistic regression, random Forest, and XGBoost techniques. Accordingly, systems and methods of the present disclosure combine results from a plurality of supervised models/techniques to improve the overall performance and robustness of the supervised learning. To improve model performance further, a probability cutoff/threshold to classify a data point as anomalous can be selected to maximize an evaluation metric (e.g., an F1-score) for a training dataset (rather than simply using a default or predetermined threshold of 0.5.

In some examples, systems and methods according to the present disclosure include a mechanism (e.g., a model explainability module) for generating and providing an explanation for observed anomalies as a function of the input metrics to the supervised models. In this manner, human operators can observe and interpret the factors resulting in the detected anomaly. In an example, one or more machine learning techniques (e.g., SHapley Additive exPlanations, or SHAP) are used to provide an analysis of the prediction of a model by computing the influence of each metric on a predicted outcome (e.g., by assigning each feature or metric an importance value that represents the contribution of that metric to the predicted output).

In some examples, systems and methods according to the present disclosure are further configured to perform drift detection (e.g., using an error analysis module). Drift detection may include detecting both model drift and data drift. In this manner, the models are configured to self-tune in accordance with changes in model accuracy and precision and changes in the data over time. Accordingly, these systems and methods can be autonomous and used in production environments with minimal human intervention (e.g., without requiring data scientists to correct model and data drift). As one example, a Kolmogorov-Smirnov (K-S) test may be implemented to detect data and target drift of numerical features, while a Population Stability Index may be used to measure changes in categorical features.

FIG. 1B generally illustrates an example anomaly detection system 140 implemented by the system 100 of FIG. 1A. The system 140 includes an unsupervised anomaly labeling portion 144, a supervised model training portion 148, a model inference portion 152, and a model audit and explainability portion 156. As described below in more detail, the unsupervised anomaly training portion 144 is configured to use an ensemble of unsupervised anomaly detection models to label data points (e.g., as anomalous or non-anomalous) contained in unlabeled training data as described below in more detail. The supervised model training portion 148 is configured to use the labeled data points to train an ensemble of supervised anomaly detection models to perform anomaly detection inference tasks on unlabeled data points in real-time. The model inference portion 152 is configured to then use an ensemble of trained, supervised anomaly detection models to perform inference tasks on real-time time series data obtained from a telecommunications network. The model audit and explainability portion 156 includes one or more components configured to perform various techniques to improve anomaly detection.

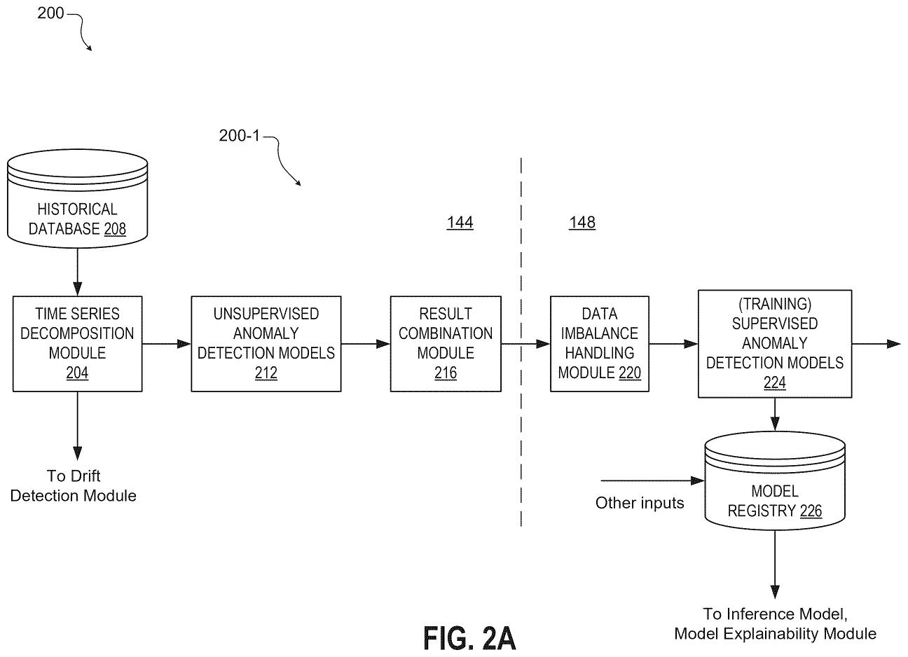

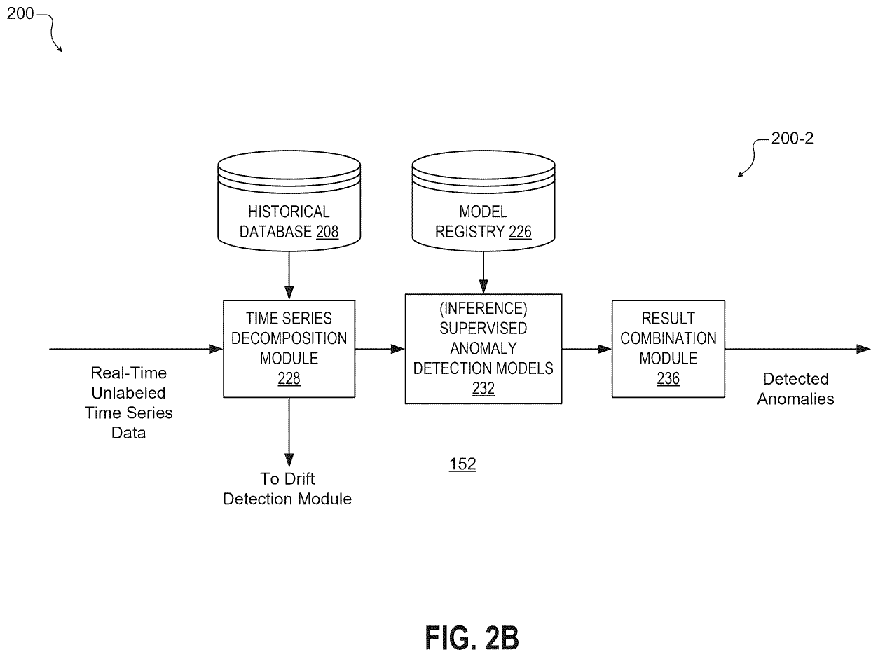

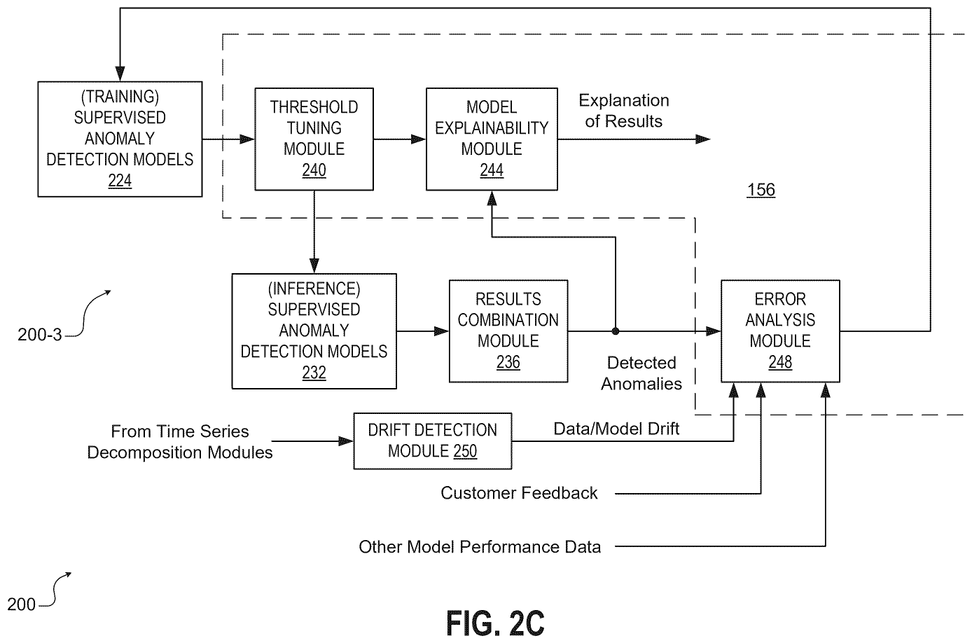

FIGS. 2A, 2B, and 2C illustrate an example anomaly detection system 200 according to the present disclosure. Various components of the anomaly detection system 200 correspond to portions of the system 140 described in FIG. 1B. For example, FIG. 2A shows a training portion 200-1 of the anomaly detection system 200, which performs functions related to the unsupervised anomaly labeling portion 144 and the supervised model training portion 148. FIG. 2B shows an inference portion 200-2 of the anomaly detection system 200, which performs functions related to the model inference portion 152. FIG. 2C shows a results and error analysis portion 200-3 of the anomaly detection system 200, which performs functions related to the model audit and explainability portion 156. The portions 200-1, 200-2, and 200-3 are referred to collectively as the anomaly detection system 200). The training portion 200-1, the inference portion 200-2, and the results and error analysis portion 200-3 may be implemented by or on same or separate computing devices, processors, servers, etc.

The training portion 200-1 is configured to use an ensemble of unsupervised anomaly detection models to label data points (e.g., as anomalous or non-anomalous) contained in unlabeled training data and then use the labeled data points to train an ensemble of supervised anomaly detection models to perform anomaly detection inference tasks on real-time time series data. As shown in FIG. 2A, the training portion 200-1 includes a time series decomposition module 204 configured to perform time series decomposition on time series data (e.g., raw physical data and measurements contained in historical unlabeled time series data, such as time series data stored in a historical database 208) to remove trend and seasonality and extract the residuals. Accordingly, the extracted residuals contain a plurality of unlabeled data points of the training time series data with the effects of trend and seasonality removed.

The time series decomposition module 204 provides the unlabeled data points contained in the residuals to unsupervised anomaly detection models 212. The unsupervised anomaly detection models 212 are configured to, using the unlabeled data points contained in the residuals, obtain and output labeled anomalies. As described herein, labeling anomalies may include both labeling some data points as anomalous while labeling other data points as non-anomalous. The unsupervised anomaly detection models 212 separately and independently identify (e.g., label) anomalies in the data points in the residuals and provides the labeled anomalies to a result combination module 216. Accordingly, for a given data point, one or more of the unsupervised anomaly detection models 212 may identify and label the data point as an anomaly while one or more others of the unsupervised anomaly detection models 212 do not label the data point as an anomaly.

Outputs of the unsupervised anomaly detection models 212 are provided to an ensemble algorithm (e.g., as implemented by the result combination module 216) configured to generate and output labeled anomalies (e.g., a combined result or output) based on the combined outputs of the unsupervised anomaly detection models 212. In an example, the ensemble algorithm is implemented as a majority voting algorithm. The majority voting algorithm is configured to select, for a given data point, a most common result (i.e., anomalous or non-anomalous) from the outputs of the unsupervised anomaly detection models 212. For example, the majority voting algorithm may label a data point as an anomaly only in response to more than half of the unsupervised anomaly detection models 212 labeling the data point as an anomaly. In other examples, the ensemble algorithm is implemented as a weighted average algorithm, a combination majority voting/weighted average algorithm, etc. An output of the result combination module 216 corresponds to labeled time series data including labeled data points contained in the extracted residuals (e.g., data points labeled anomalous or non-anomalous).

Typically, the proportion of anomalies in the time series data (i.e., the number of data points labeled as anomalies relative to the total number of data points) is highly skewed/imbalanced such that a number of anomalous data points in a given sample of data points is extremely small (e.g., only several anomalous data points in hundreds or thousands of data points). Accordingly, in some examples, a data imbalance handling module 220 is configured to mitigate data imbalances (e.g., by selecting appropriate evaluation metrics, tuning model specific hyperparameters to compensate for imbalanced data, establishing a validation framework to ensure that the proportion of anomalies is similar in both training and test datasets, evaluating different sampling techniques to address the data imbalance, etc.). The data imbalance handling module 220 is configured to automatically adjust sampling of the output of the result combination module 216 to increase the proportion of labeled anomalies (e.g., by duplicating data points labeled as anomalies) relative to the total number of data points to achieve a desired proportion. In an example, the data imbalance handling module 220 increases the proportion of labeled anomalies to 20%, 30, 50%, etc. of the total number of data points. For example, out of a total number of 100 data points received from the result combination module, only 5 of the data points may be labeled as anomalies. Accordingly, the data imbalance handling module 220 may duplicate the data points labeled as anomalies (e.g., by a multiplier of 10) to increase the proportion of data points labeled as anomalies to 50%. In this manner, training of supervised anomaly detection models is facilitated since the supervised anomaly detection models are exposed to a greater number of anomalous data points.

One or more (e.g., an ensemble of) supervised anomaly detection models 224 are trained, using the labeled anomalies and non-anomalous data points, to predict anomalies in inference (e.g., real-time) data in a binary fashion (i.e., to perform inference as a binary classification task). As used herein, “binary” classification refers to predicting, in a binary fashion, whether each data point is normal or anomalous (e.g., by determining a probability that a given data point is anomalous and classifying the data point as normal or anomalous based on the probability and a probability threshold). Trained inference models may be stored in a model registry 226.

The inference portion 200-2 is configured to use an ensemble of trained, supervised anomaly detection models to label data points (e.g., as anomalous or non-anomalous) contained in unlabeled inference data, such as real-time time series data obtained from a telecommunications network. As shown in FIG. 2B, the inference portion 200-2 includes a time series decomposition module 228 (e.g., similar to the time series decomposition module 204 of FIG. 2A) configured to perform time series decomposition on real-time, unlabeled time series data (e.g., network observability data) to remove trend and seasonality and extract the residuals. In an example, the time series decomposition module 208 further receives historical unlabeled time series data from the historical database 208 to facilitate identification and removal of trend and seasonality from the time series data. One or more (e.g., an ensemble of) trained, supervised anomaly detection models 232 (e.g., corresponding to the models 224 of FIG. 2A subsequent to training) are configured to receive the residuals and label anomalous data points in the residuals. The models 232 are configured to perform a binary classification inference task such that data points output by the models 232 are labeled as either non-anomalous (normal) or anomalous.

In examples where the models 232 correspond to a plurality of models, outputs of the models 232 are provided to a results combination module 236 configured to implement an ensemble algorithm (e.g., a majority voting algorithm). Accordingly, an outputs of the result combination module 236 include data points labeled as either normal or anomalous.

Referring now to FIG. 2C, the results and error analysis portion 200-3 includes one or more components configured to perform various techniques to improve anomaly detection. For example, data points are classified as anomalous based on a probability cutoff or threshold. According, the system 200 may include a threshold tuning module 240 may be configured to adjust the threshold (e.g., increase or decrease the threshold to maximize an evaluation metric for a training dataset used to train the models 224, such as an F1-score). As an example, outputs of the models 224 include data points assigned a probability score (e.g., a value between 0 and 1) and each data point is labeled as normal or anomalous based on a determination of whether the probability score exceeds the threshold (e.g., 0.5).

In some examples, the results and error analysis portion 200-3 includes a model explainability module 244 configured to generate and provide an explanation (e.g., as raw data, a chart, graph, or table, etc.) for observed anomalies as a function of the input metrics to the supervised models 224. In this manner, human operators can observe and interpret the factors resulting in the detected anomaly. In an example, one or more machine learning techniques (e.g., SHapley Additive exPlanations, or SHAP) are used to provide an analysis of the predictions of the models 232 by computing the influence of each metric on a predicted outcome (e.g., by assigning each feature or metric an importance value that represents the contribution of that metric to the predicted output).

In some examples, the results and error analysis portion 200-3 includes an error analysis module 248 configured to perform various error analysis functions based on drift, customer feedback, and/or other model performance data. For example, a drift detection module 250 may be configured to perform various drift detection functions and provide an output indicative of drift to the error analysis module 248 (e.g., based at least in part on outputs from the time series decomposition modules 204, 228. Drift detection may include detecting both model drift and data drift. In this manner, the various models of the system 200 are configured to self-tune in accordance with changes in model accuracy and precision and changes in the data over time.

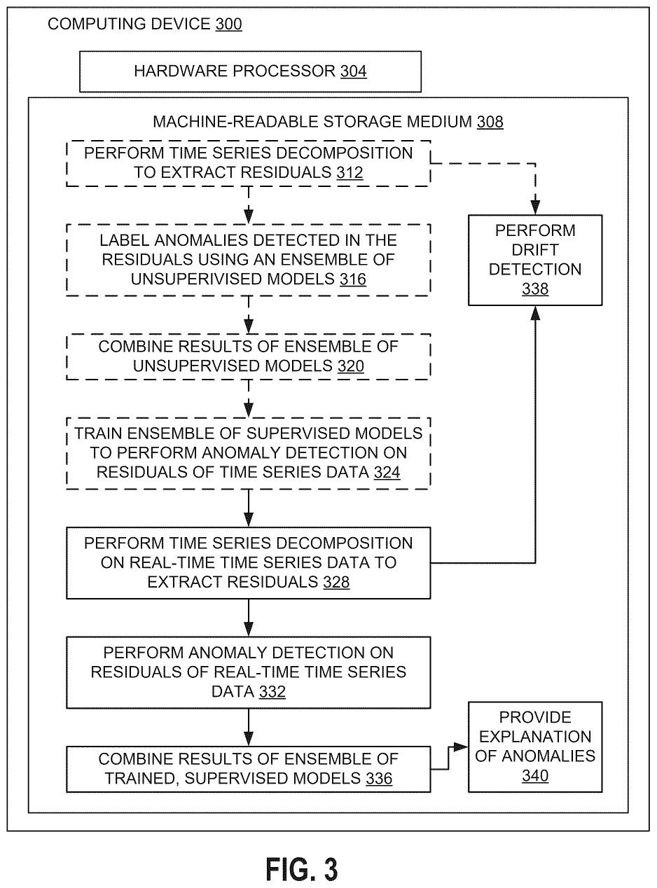

FIG. 3 illustrates a computing device or platform 300 that may be used to perform anomaly detection according to the principles of the present disclosure. The computing device 300 may be, for example, a server computer, a controller, or any other similar computing device configured to process data. In the example implementation of FIG. 3, the computing device 300 includes a hardware processor 304 and machine-readable storage medium 308.

The hardware processor 304 may be one or more central processing units (CPUs), semiconductor-based microprocessors, and/or other hardware devices suitable for retrieval and execution of instructions stored in the machine-readable storage medium 308. The hardware processor 308 may fetch, decode, and execute instructions to control processes or operations for anomaly detection. As an alternative or in addition to retrieving and executing instructions, the hardware processor 304 may include one or more electronic circuits that include electronic components for performing the functionality of one or more instructions, such as a field programmable gate array (FPGA), application specific integrated circuit (ASIC), or other electronic circuits.

The machine-readable storage medium 308 may be any electronic, magnetic, optical, or other physical storage device that contains or stores executable instructions. Thus, the machine-readable storage medium 308 may be, for example, Random Access Memory (RAM), non-volatile RAM (NVRAM), an Electrically Erasable Programmable Read-Only Memory (EEPROM), a storage device, an optical disc, and the like. In some examples, the machine-readable storage medium 308 may be a non-transitory storage medium, where the term “non-transitory” does not encompass transitory propagating signals. As described in detail below, the machine-readable storage medium 308 may be encoded with executable instructions as described below in more detail.

The instructions performed by the hardware processor 304 may include instructions performed in a training phase (a design time, shown in dashed lines) and functions performed in an inference phrase (a run time, shown in solid lines). For example, the hardware processor 304 may execute instruction 312 to perform time series decomposition on training time series data (or, “training data”) to remove trend and seasonality and extract residuals. For example, the training time series data includes unlabeled historical time series data (e.g., raw physical data and measurements contained in historical time series data) corresponding to operation of a telecommunications network, such as historical time series data previously collected and stored in a database. Accordingly, the extracted residuals contain a plurality of unlabeled data points of the training time series data with the effects of trend and seasonality removed. In an example, the training time series data corresponds to observability data of the telecommunications network (e.g., a 5G cellular network), but in other examples may correspond to other types of data, networks, and/or systems.

The hardware processor 304 may execute instruction 316 to label anomalies (anomalous data points) detected in the residuals using a plurality/ensemble of unsupervised anomaly detection models. For example, each data point contained in the residuals is labeled as an anomaly (an anomalous data point) or as “normal” (a non-anomalous data point). The unsupervised anomaly detection modules may include at least two (i.e., two or more) of a K-means clustering model, a density-based spatial clustering of applications with noise (DBSCAN) model, a Gaussian mixture model, an isolation forest model, a local outlier factor model, a robust covariance model, and a one class support vector machine model. The unsupervised anomaly detection modules may include other types of AI or MI models.

The hardware processor 304 may execute instruction 320 to combine results from the ensemble of unsupervised anomaly detection models (i.e., data points labeled as anomalous or non-anomalous by the respective unsupervised anomaly detection models). In other words, for a given data point, the unsupervised anomaly detection models may generate different results (e.g., one or more of the unsupervised anomaly detection models may label a given data point as anomalous while one or more others of the unsupervised anomaly detection models may label the same data point as non-anomalous). Combining the results from the ensemble of unsupervised anomaly detection models may be achieved using an ensemble algorithm. In an example, the ensemble algorithm is a majority voting algorithm. In another example, the ensemble algorithm may include a weighted average algorithm or a combination majority voting/weighted average algorithm.

The hardware processor 304 may execute instruction 324 to train, using the results (i.e., the labeled anomalies) from the ensemble of unsupervised anomaly detection models, an ensemble of supervised anomaly detection models to perform anomaly detection (e.g., binary classification inference tasks) on residuals of time series data (inference time series data, which may include real-time time series data). The supervised anomaly detection models may include the same or different types of models as the unsupervised anomaly detection models. In this manner, the supervised anomaly detection models are trained to predict anomalies in real-time as a binary classification task (i.e., to predict, in a binary fashion, whether a given data point is “non-anomalous” or “anomalous”). As an example, the supervised anomaly detection models are trained to assign a probability score (e.g., a value between 0 and 1) to data points, which can then be labeled as non-anomalous (“normal”) or anomalous based on a determination of whether the probability score exceeds an adjustable threshold (e.g., 0.5).

The hardware processor 304 may execute instruction 328 to perform time series decomposition on inference (e.g., real-time) time series data to remove trend and seasonality and extract residuals. For example, the inference time series data is real-time time series network observability data obtained from a telecommunications network. The inference time series data includes unlabeled time series data (e.g., raw physical data and measurements contained in time series network observability) corresponding to operation of the telecommunications network. Accordingly, the extracted residuals contain a plurality of unlabeled data points of the inference time series data with the effects of trend and seasonality removed.

The hardware processor 304 may execute instruction 332 to perform anomaly detection on the unlabeled data points contained in the residuals using (e.g., an ensemble of) the trained, supervised anomaly detection models (e.g., corresponding to the supervised anomaly detection models trained in response to instruction 324. For example, the supervised anomaly detection models are configured to perform a binary classification inference task to label data points as either non-anomalous (normal) or anomalous. As described above, the supervised anomaly detection models assign a probability score to the data points, which can then be labeled as non-anomalous or anomalous based on a determination of whether the probability score exceeds an adjustable threshold. Accordingly, for a given data point, instruction 332 results in a plurality of results labeling the data point as non-anomalous or anomalous (i.e., corresponding to outputs of respective supervised anomaly detection models).

The hardware processor 304 may execute instruction 336 to combine results from the ensemble of supervised anomaly detection models (i.e., data points labeled as anomalous or non-anomalous by the respective supervised anomaly detection models). As described above, for a given data point, the supervised anomaly detection models may generate different results (e.g., one or more of the supervised anomaly detection models may label a given data point as anomalous while one or more others of the supervised anomaly detection models may label the same data point as non-anomalous). Combining the results from the ensemble of supervised anomaly detection models may be achieved using an ensemble algorithm (e.g., a majority voting algorithm, a weighted average algorithm, a combination majority voting/weighted average algorithm, etc.).

A system (e.g., the system 100, the system 200, etc.) may be configured to perform one or more actions or functions based on outputs of the hardware processor, such as outputs resulting from instruction 336 identifying detected anomalous data points. As one example, one or more corrective actions may be taken to repair or mitigate issues caused by or causing the anomalous data points. As another example, alerts may be generated and transmitted to various entities (users, administrators, IT professionals, etc.) associated with the system or telecommunications network. As another example, one or more reports may be generated identifying the anomalous data points, input metrics causing the anomalous data points, etc.

The hardware processor 304 may be configured to execute one or more instructions to perform model explainability, drift detection, and/or other error analysis functions as described above in FIG. 2C. For example, the hardware processor 304 may execute instruction 338 to perform drift detection functions, such as by analyzing and comparing time series decomposition data as described above. The hardware processor 304 may be configured to execute instruction 340 to provide an explanation for observed anomalies as a function of the input metrics to the supervised models.

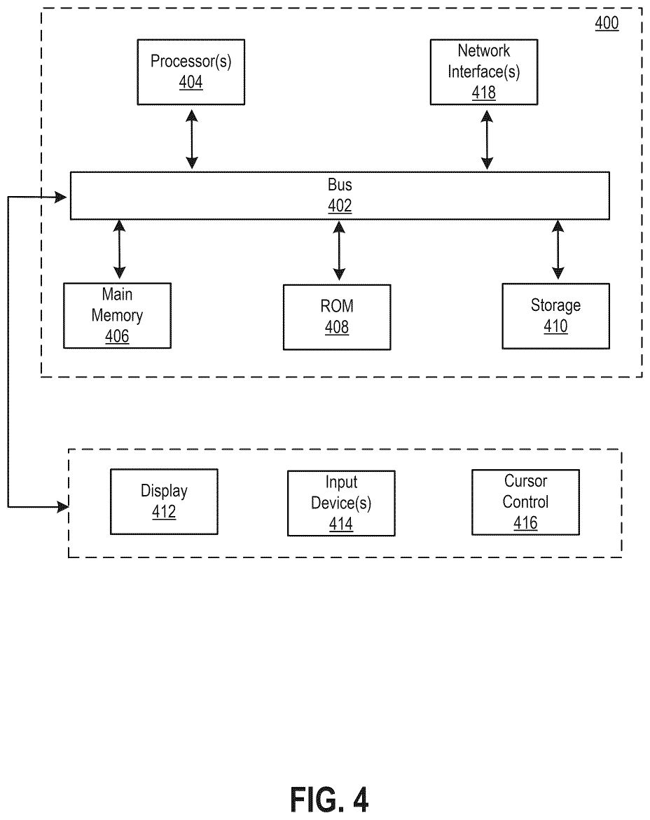

FIG. 4 depicts a block diagram of an example computer system 400 in which various examples of the disclosed technology described herein may be implemented. The computer system 400 includes a bus 402 or other communication mechanism for communicating information, one or more hardware processors 404 coupled with the bus 402 for processing information. The hardware processor(s) 404 may be, for example, one or more general purpose microprocessors.

The computer system 400 also includes a main memory 406, such as a random access memory (RAM), cache and/or other dynamic storage devices, coupled to the bus 4002 for storing information and instructions to be executed by the processor 404. The main memory 406 also may be used for storing temporary variables or other intermediate information during execution of instructions to be executed by the processor 404. Such instructions, when stored in storage media accessible to the processor 404, render the computer system 400 into a special-purpose machine that is customized to perform the operations specified in the instructions.

The computer system 400 further includes a read only memory (ROM) 408 or other static storage device coupled to the bus 402 for storing static information and instructions for the processor 404. A storage device 410, such as a magnetic disk, optical disk, or USB thumb drive (Flash drive), etc., is provided and coupled to the bus 402 for storing information and instructions.

The computer system 400 may be coupled via the bus 402 to a display 412, such as a liquid crystal display (LCD) (or touch screen), for displaying information to a computer user. An input device 414, including alphanumeric and other keys, is coupled to the bus 402 for communicating information and command selections to the processor 404. Another type of user input device is cursor control 416, such as a mouse, a trackball, or cursor direction keys for communicating direction information and command selections to processor 404 and for controlling cursor movement on the display 412. In some examples, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs configure the computer system 400 to be a special-purpose machine. According to one example of the disclosed technology, the techniques herein are performed by the computer system 400 in response to the processor(s) 404 executing one or more sequences of one or more instructions contained in main memory 406. Such instructions may be read into the main memory 406 from another storage medium, such as the storage device 410. Execution of the sequences of instructions contained in the main memory 406 causes the processor(s) 404 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as the storage device 410. Volatile media includes dynamic memory, such as the main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus 402. Transmission media can also take the form of acoustic or light waves, such as those generated during radio-wave and infra-red data communications.

The computer system 400 also includes a communication (e.g., network) interface 418 coupled to the bus 402. The network interface 418 provides a two-way data communication coupling to one or more network links that are connected to one or more local networks. For example, the network interface 418 may be an integrated services digital network (ISDN) card, cable modem, satellite modem, or a modem to provide a data communication connection to a corresponding type of telephone line. As another example, the network interface 418 may be a local area network (LAN) card to provide a data communication connection to a compatible LAN (or a WAN component in communication with a WAN). Wireless links may also be implemented. In any such implementation, the network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through the network interface 418, which carry the digital data to and from the computer system 400, are example forms of transmission media.

The computer system 400 can send messages and receive data, including program code, through the network(s), network link, and the network interface 418. In the Internet example, a server might transmit a requested code for an application program through the Internet, the ISP, the local network and the network interface 418.

The received code may be executed by the processor 404 as it is received, and/or stored in the storage device 410, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a module or circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit or module. In implementation, the various circuits or modules described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system configured to carry out the functionality described with respect thereto, such as the computer system 400.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system for performing anomaly detection, the system comprising:
a processor; and
memory comprising instructions that, when executed, cause the processor to:
perform time series decomposition on training time series data to extract residuals of the training time series data, the residuals including a plurality of data points of the training time series data;
using an ensemble of unsupervised anomaly detection models, identify and label anomalous data points from among the plurality of data points contained in the residuals;
based on outputs from the ensemble of unsupervised models including the labeled anomalous data points, obtain a combined output indicating the labeled anomalous data points;
using the combined output, train an ensemble of supervised anomaly detection models to detect anomalies in inference time series data; and
using the trained ensemble of supervised anomaly detection models, generate respective outputs identifying anomalous data points in real-time, inference time series data.

2. The system of claim 1, wherein the inference time series data includes network observability data.

3. The system of claim 2, wherein the network observability data corresponds to a telecommunications network.

4. The system of claim 3, wherein the telecommunications network includes a 5G cellular network, and wherein the network observability data corresponds to the 5G cellular network.

5. The system of claim 1, wherein obtaining the combined output includes obtaining the combined output using a majority voting algorithm.

6. The system of claim 1, wherein the ensemble of unsupervised anomaly detection models include at least two of a K-means clustering model, a density-based spatial clustering of applications with noise (DBSCAN) model, a Gaussian mixture model, an isolation forest model, a local outlier factor model, a robust covariance model, and a one class support vector machine model.

7. The system of claim 1, wherein the unsupervised anomaly detection models are machine learning models.

8. The system of claim 1, the memory further comprising instructions that, when executed, cause the processor to:
using the respective outputs of the trained ensemble of supervised anomaly detection models, obtain a second combined output indicating the labeled anomalous data points in the inference time series data.

9. A system for performing anomaly detection, the system comprising:
a time series decomposition module configured to perform time series decomposition on training time series data to extract residuals of the training time series data, the residuals including a plurality of data points of the training time series data;
a plurality of unsupervised anomaly detection models configured to identify and label anomalous data points from among the plurality of data points contained in the residuals;
a result combination module configured to, based on outputs from the plurality of unsupervised anomaly detection models including the labeled anomalous data points, obtain a combined output indicating the labeled anomalous data points; and
a plurality of supervised anomaly detection models trained using the combined output and configured to generate respective outputs identifying anomalous data points in real-time time series data.

10. The system of claim 9, wherein the real-time time series data includes network observability data of a telecommunications network.

11. The system of claim 9, wherein the result combination module is configured to execute a majority voting algorithm to obtain the combined output.

12. The system of claim 9, wherein the plurality of unsupervised anomaly detection models include at least two of a K-means clustering model, a density-based spatial clustering of applications with noise (DBSCAN) model, a Gaussian mixture model, an isolation forest model, a local outlier factor model, a robust covariance model, and a one class support vector machine model.

13. The system of claim 9, further comprising a data imbalance handling module configured to receive the combined output and adjust a sampling rate of the labeled anomalous data points indicated by the combined output.

14. The system of claim 9, further comprising a second time series decomposition module configured to perform time series decomposition on the real-time time series data to extract residuals of the real-time time series data, the residuals including a plurality of data points of the real-time time series data, wherein the plurality of supervised anomaly detection models is configured to generate the respective outputs using the residuals of the real-time time series data.

15. The system of claim 14, further comprising a second result combination module configured to obtain a second combined output indicating the labeled anomalous data points in the real-time time series data.

16. The system of claim 9, wherein the plurality of supervised anomaly detection models is configured to generate the respective outputs by determining respective probabilities associated with the anomalous data points in the real-time time series data and comparing the respective probabilities to a threshold.

17. The system of claim 16, further comprising a threshold tuning module configured to adjust the threshold.

18. The system of claim 9, further comprising a model explainability module configured to generate and output data indicating input metrics that resulted in the labeled anomalous data points.

19. The system of claim 9, further comprising a drift detection module configured to at least one of (i) detect drift in the real-time time series data and (ii) detect drift in one or more of the plurality of supervised anomaly detection models.

20. A system for performing anomaly detection, the system comprising:
a processor; and
memory comprising instructions that, when executed, cause the processor to:
receive training time series data corresponding to network observability data of a telecommunications network;
using an ensemble of unsupervised anomaly detection models, identify and label anomalous data points from among a plurality of data points contained in the training time series data;
based on outputs from the ensemble of unsupervised models including the labeled anomalous data points, obtain, using a majority voting algorithm, a combined output indicating the labeled anomalous data points;
using the combined output, train an ensemble of supervised anomaly detection models to detect anomalies in real-time time series data received from the telecommunications network; and
using the trained ensemble of supervised anomaly detection models, generate respective outputs identifying anomalous data points in the real-time time series data.
